(19) United States
(12) Patent Application Publication
(10) Pub. No.: US 2012/0153626 A1
(43) Pub. Date: Jun. 21, 2012

(54) APPARATUS FOR EXTRACTING ENERGY FROM WAVES TRAVERSING A BODY OF WATER

(76) Inventors: Arthur M.G. McFarlane, Hamlin, NY (US); Stuart R. McFarlane, Spencerport, NY (US)

(21) Appl. No.: 13/328,933

(22) Filed: Dec. 16, 2011

(51) Int. Cl. F03B 13/24

(52) U.S. Cl. 290/53

(57) ABSTRACT

An apparatus for extracting energy from waves traversing a body of water includes first and second tanks submerged in a body of water, first and second floating flap valves, a conduit, an air-propelled motor, and a valve. The tanks are spaced apart in the direction of movement of a wave, each has an opening close to the bottom for allowing water to enter, an air outlet above the opening, and contains a volume of air. The flap valves are arranged one in each of the tanks to selectively allow air to flow between the respective tank and the associated tank outlet but prevent the flow of water out the tank outlet. The conduit connects the tank outlets of the first and second tanks. The valve is disposed in the conduit and has first and second valve outlets directing air through the motor.

### BACKGROUND OF THE INVENTION

This invention relates to energy. More specifically, this invention relates to green energy extracted from waves traversing a body of water such as a lake or an ocean.

### BRIEF DESCRIPTION OF THE RELATED ART

Whether because of government regulation, fear of pollution or belief that natural resources are being rapidly depleted, green energy has become a focus of many in recent years. As people have looked to distance themselves from coal, oil, and natural gas, they have increasingly looked to more abundant and renewable resources such as wind, solar power, and water. Several individuals have sought to extract energy from waves or other bodies of water only to find that these proposed solutions are “perpetual motion machines” and thus can never practically be built. Other attempts, like that shown in U.S. Pat. No. 3,989,951 to Lesster et al. have sought to submerge components under water which would be acted on by changing pressures of a body of water, but they too are inefficient, need to be regularly replaced or repaired, and/or are hazardous to sea going vessels and sea creatures.

Thus, there is a need in the art for a system and apparatus that efficiently and effectively extracts energy from waves traversing a body a water.

There also is a need for an apparatus that can be used to create calm from otherwise choppy waters, e.g., to promote formation of beaches and harbors, or create a calm work area for construction purposes.

### SUMMARY OF THE INVENTION

The present invention remedies the foregoing deficiencies in the art by providing an improved apparatus for extracting energy from waves traversing a body of water.

In one aspect, an apparatus according to the invention includes first and second tanks submerged in a body of water, first and second floating flap valves, a conduit, an air-propelled motor, a valve, and a generator. The tanks are spaced apart in the direction of movement of a wave, each has an opening close to the bottom for allowing water to enter, an air outlet above the opening, and contains a volume of air. The flap valves are arranged one in each of the tanks to selectively allow air to flow between the respective tank and the associated tank outlet but prevent the flow of water out the tank outlet. The conduit connects the tank outlets of the first and second tanks. The valve is disposed in the conduit and has first and second valve outlets directing air through the motor from the tank outlet associated with the one of the first and second tanks having a higher pressure to the tank outlet associated with the other of the first and second tanks having a lower pressure. The generator is connected to the motor for converting rotation of the motor into electricity.

In another aspect, the invention includes a flywheel disposed between the motor and the generator.

An understanding of these and other aspects, features, and benefits of the invention may be had with reference to the attached figures and following disclosure, in which preferred embodiments of the invention are illustrated and described.

### BRIEF DESCRIPTION OF THE DRAWING FIGURES

FIG. 1 is a schematic view of an apparatus for extracting energy from waves traversing a body of water according to a first embodiment of the invention.

FIG. 2 is a plan view of Section 2-2 in FIG. 1.

FIG. 3 is a plan view of Section 3-2 in FIG. 1.

FIG. 4 is a schematic view of an apparatus for extracting energy from waves traversing a body of water according to an alternative embodiment of the invention.

FIG. 5 is a plan view of a plurality of apparatus arranged in a body of water according to an embodiment of the invention.

FIG. 6 is a plan view of a plurality of apparatus arranged in a body of water according to another embodiment of the invention.

### DETAILED DESCRIPTION OF THE INVENTION

As noted above, the present invention relates to extracting energy from waves traversing a body of water. While the inventors envision the apparatus being submerged in a body of water such as an ocean or a lake, the invention is not limited to these locales. Any body of water, whether naturally occurring or man-made, in which water is moving in waves could have the potential for application of this invention.

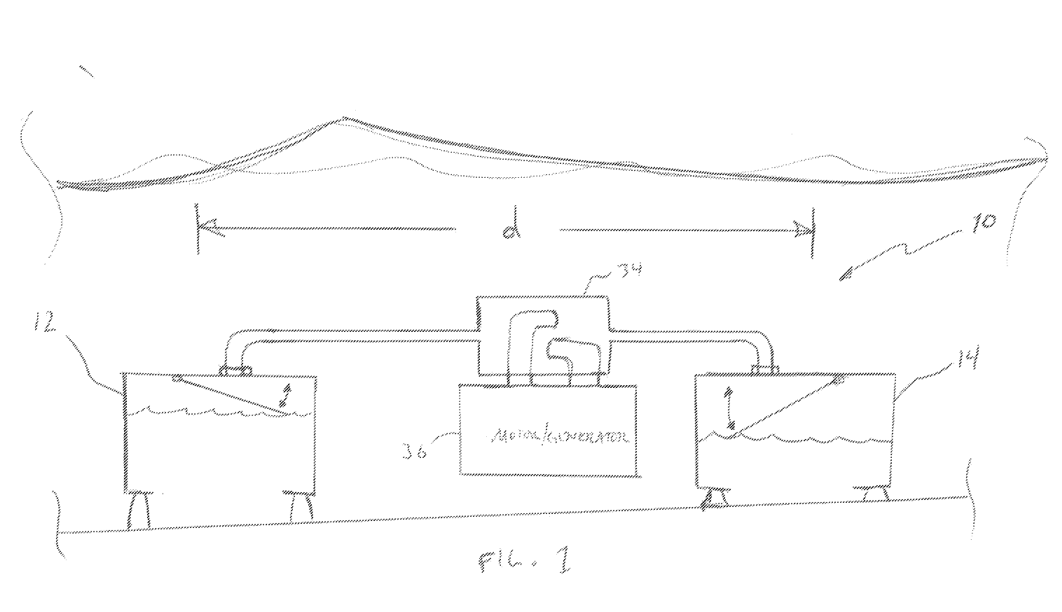

FIG. 1 illustrates a first embodiment of an apparatus for extracting energy from waves in a body of water. FIG. 1 shows an apparatus 10 including a first vessel or tank 12 and a second vessel or tank 14 spaced from the first tank 12. The tanks 12, 14 are illustrated as having the same construction, which may any construction suitable for this application. Preferably, the tanks 12, 14 each include a side wall or side walls 16, a closed top 17 and an open bottom 18. Accordingly, when the tanks 12, 14 are submerged in water, water will enter through the open bottom and an air pocket or volume of air will be entrapped above water in each of the tanks 12, 14. The first tank 12 also includes a first outlet 28 extending through its top 17. Similarly, the second tank 16 includes a second outlet 30 extending through its top 17. First and second floating values 20, 22 are disposed in the respective first and second tanks 12, 14. These valves 20, 22 are arranged to be disposed in the volume of air and float on the water occupying each of the tanks 12, 14. In the illustrated embodiment, the valves 20, 22 are attached to the top of the respective tanks 12, 14 at a pivot point 24, 26. The valves 20, 22 are flaps in this embodiment. In operation, as the water level rises in either of the tanks 12, 14, the respective flap 20, 22 rises toward the top 17 of the tank. When one of the tanks 12, 14 is fully filled with water, the flap will cover the respective outlet 28, 30 of the tank to prevent flow of water out of the tank through the outlet 28, 30.

Although the floating valves 20, 22 are shown as flaps disposed to rotate about pivot points, any floating device that is aligned with the outlet and will substantially prevent water from exiting through the outlet will suffice for the invention. The purpose of the flap is to prevent water from flowing out the outlet 28, 30 to prevent water from entering other components of the apparatus 10, which will be described in more detail below. In other embodiments, the valves 20, 22 may not be necessary, as it may be possible through appropriate component sizing to ensure that water will never rise high enough in the respective tanks 12, 14 to exit through the outlet 28, 30.

Although the tanks are shown as having open bottoms, they need not. Any opening spaced from the top of the tank that allows water to enter the tank will allow a volume of air to accumulate in the top of the tank. Moreover, although the outlets 28, 30, are shown as formed in the top of the tank, they may be formed anywhere that allows for some or all of the volume of air to leave the tank.

A conduit 32 is in fluid communication with and extends between the first and second outlets 28, 30 of the respective first and second tanks 12, 14. As illustrated, the conduit 32 is arranged essentially horizontally. The conduit may be any suitable conduit including but not limited to a steel or polymer-based pipe.

In operation, the first and second tanks 12, 14 may be arranged substantially horizontal, i.e., are disposed at substantially the same depth below a normal water surface. They are also separated by a distance D, in the direction of wave propagation across the body of water. The distance D is preferably one-half the period of waves propagating in the body of water. Thus, as the crest of a wave passes over one of the tanks 12, 14, the trough of the wave is disposed directly above the other of the tanks 12, 14.

As will be appreciated, the tanks 12, 14 are arranged in the direction of travel of the wave. As a wave crests over the first tank, the water level within that tank rises owing to increased water pressure, pressing air in the head space out the outlet 28 and into the conduit 32. Because the trough of the wave is simultaneously passing over the second tank 14, the water level lowers in that tank, due to decreased water pressure, increasing the amount of air in the head space. As the wave continues and the crest approaches and passes over the second tank 14, the water level rises in that tank forcing air out the outlet 30 of the second tank 14 and into the conduit 32. While the water level simultaneously lowers in the first tank 12, causing air from the conduit 32 to enter the first tank 12 through the first outlet 28. As waves continuously propagate over the first and second tanks, this back and forth of air in the conduit continues.

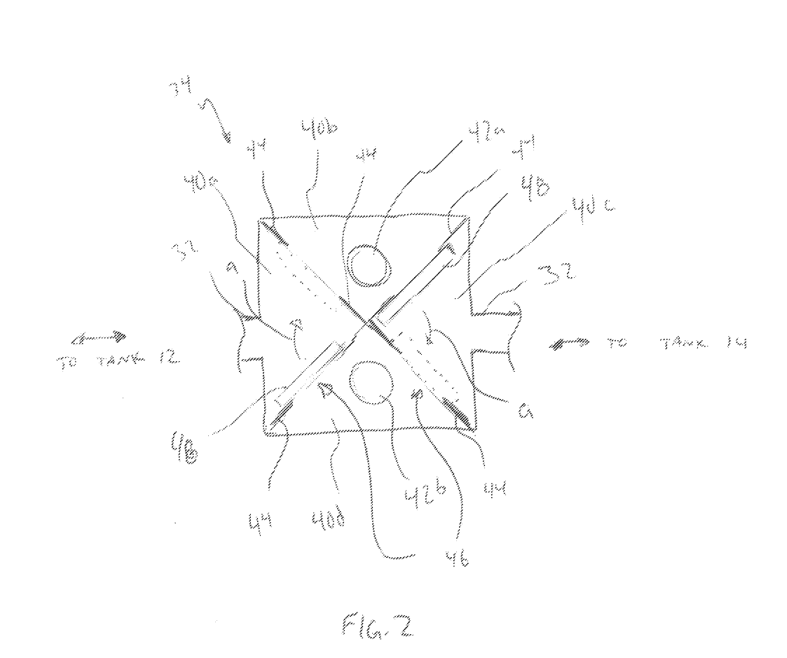

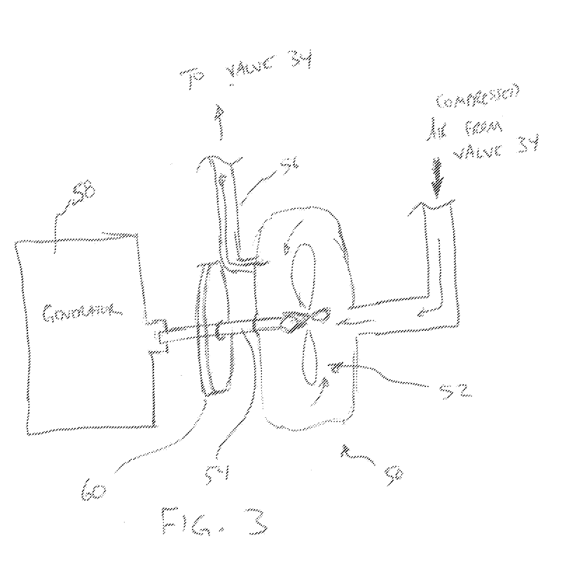

A valve 34 is disposed in the conduit 32 to redirect the moving air to a housing 36 containing an air motor and a generator. FIG. 2 is a schematic cross-section of a valve 34 according to one embodiment of the invention. FIG. 3 shows the air motor and generator combination schematically.

Turning first to FIG. 2, the valve 34 is disposed in the conduit 32 to redirect the air propagating between the first and second tanks 12, 14 so that air flows through the air motor in the same direction as the air flows through the conduit reverses as waves pass. The valve 34 generally includes 4 chambers 42a-40d with chamber 40a being in fluid communication with the conduit 32 attached to the first tank 12 and chamber 40c being in fluid communication with the conduit 32 in communication with the second tank 14. A valve outlet 42a and a valve inlet 42b are positioned in the second and fourth chambers 40b, 40d, respectively. Walls 44 are positioned between each of the chambers and define an open passageway 46 to allow air to pass between adjacent chambers. Two flaps 48 are supported in the first and third chambers 40a, 40c and are moveable in the direction shown by arrow A between the illustrated position and the position shown in dotted lines.

In operation, when the flaps 48 are disposed at the positions illustrated in FIG. 2, air entering through the left side of the figure, i.e., from tank 12, enters the first chamber 40a and passes into the second chamber 40b. In this configuration, the flaps 48 seal the open passageways between the sealed third chambers and the first and forth chambers, to prevent air from entering the third chamber and the fourth chamber. From the second chamber 40b, air exits the valve 34 through the valve outlet 42a. As will be described in more detail below, this air leaving through the valve outlet 42a is fed into an air motor or the like that converts the flowing air into rotational motion that can be extracted as energy. At the same time, that air is entering from tank 12 and being supplied to the motor through valve outlet 42a, the pressure in the second tank 14 is lowered, so air is flowing into the tank 14. An outlet of the air motor is connected to valve inlet 42b such that air exhausted from the air motor enters the fourth chamber 40d through the valve inlet 42b then passes into the third chamber 40c and out the conduit 32 to tank 14 to occupy the head space created by a decreasing water level in tank 14.

The just described operation is the general operation of the valve when a crest of the wave is passing over the first tank 12. As noted above, when the crest of a wave passes over the tank, the water level in the tank rises forcing air in the head space to rush out through the tank outlet into the conduit. As the wave continues to propagate across the apparatus and the crest approaches and subsequently passes the second tank, the flaps 48 in the valve 34 are rotated along arrow A to the position shown in dotted lines.

When the wave is cresting over the second tank 14, pressurized air leaves the tank 14, passes from the conduit 32 into the third chamber 40c of the valve, proceeds into the second chamber 40b where it leaves the valve 34 through the valve outlet 42a and then flows to the inlet side of the air motor. Air leaving the air motor from the return enters the valve 34 through the valve inlet 42b, into the fourth chamber 40d. That exhaust air then passes into the first chamber 40a and out the conduit 32 to the first tank 12. Although not illustrated, an air cylinder or similar actuator may be provided to move the flaps 48 between the illustrated position and the position shown in dotted lines in FIG. 2. The cylinder would be timed to move the flaps consistent with changing pressures in the tanks 12, 14. Limit switches or pressure switches may be provided at the tanks to ensure appropriate timing of the flap 48 movement.

Although the valve 34 has been described in connection with FIG. 2, other embodiments of the valve may be used. The valve is generally only required to take pressurized air from one of the tanks and feed that pressurized air into an air motor, and take exhaust or return air from that motor and provided it to the lower pressured tank. Those of ordinary skill in the valve arts may appreciate alternative valve designs after being educated by this disclosure provided herein, and such designs are included within the scope of the invention.

As noted above, high pressure air continuously leaves the valve through the first outlet 42a and is provided, via a first conduit 54 or the like to an air motor. Such an air motor is schematically illustrated in FIG. 3. There, the housing 36 shown in FIG. 1 has been removed for ease of understanding, and illustrated is an air motor 50 having an impeller 52 disposed therein. The impeller 52 is generally arranged in the path of the flow of air provided from the valve 34. As this compressed air enters the air motor 50 from the valve 34, and more specifically from the valve outlet 42A, the impeller rotates consequently rotating a shaft 54. Air is exhausted from the air motor 50 via a second conduit 56 which is fed to the valve inlet port 42b for exhausting into the lower pressure tank of the two tanks 12, 14. The shaft 54 is in communication with the generator 58, which converts the rotational motion of the shaft 54 into electricity using conventional methods.

The air motor 50 is shown generally schematically in FIG. 3 and may take any number of configurations. Any conventional or developed impeller design that will convert a flow of compressed air thereacross into a rotational movement could be used without departing from the spirit of the scope of the invention.

Other components may also be provided in the encasement 36 to facilitate improved throughput and or operation of the motor 50/generator 58 combination. For example, FIG. 3 also illustrates a fly wheel 60 disposed on the shaft 54 to ensure continued rotation of the shaft 54. This may be particularly useful because compressed air from the valve 34 is provided only in bursts or at intervals, not as a continuous flow of compressed air, owing to the fact that the air alternately comes from the first and second tanks 12, 14. A clutch, such as a one way clutch (not illustrated) may also be provided on the shaft, between the motor 50 and the generator 58.

In the preceding embodiments the apparatus is described in terms of a four-way valve directing compressed air flowing alternately from first and second tanks to an inlet of an air-driven motor. Other embodiments also are contemplated. The back-and-forth of compressed air owing to substantially simultaneously increasing and decreasing water pressures in the first and second tanks may also be used directly to power a generator, i.e., without a valve. For example, impeller designs are known that create rotation in a single direction when acted on from air flowing in opposite direction. Such an impeller is used, for example, in a Wells turbine. Such an impeller could be disposed in the conduit, for example, or in a housing separate from the conduit, to be acted on by the air cycling between the tanks. When a separate housing is used to house the impeller, a valve, such as a check valve, will likely still be required in the conduit.

As should be appreciated from the foregoing description, the inventors have devised a way to extract energy from continually propagating waves across a body of water. The energy extracted is lost energy, lost from the propagating waves. Thus, downstream of tank 14, the inventors have found that the amplitude of the waves is significantly diminished, and in some instances the water may be close to calm. The invention is therefore useful not only to create electrical energy but can create calm water, which may be useful in particularly choppy areas of ocean or lakes, e.g., to promote formation of sandy beaches, harbors and the like.

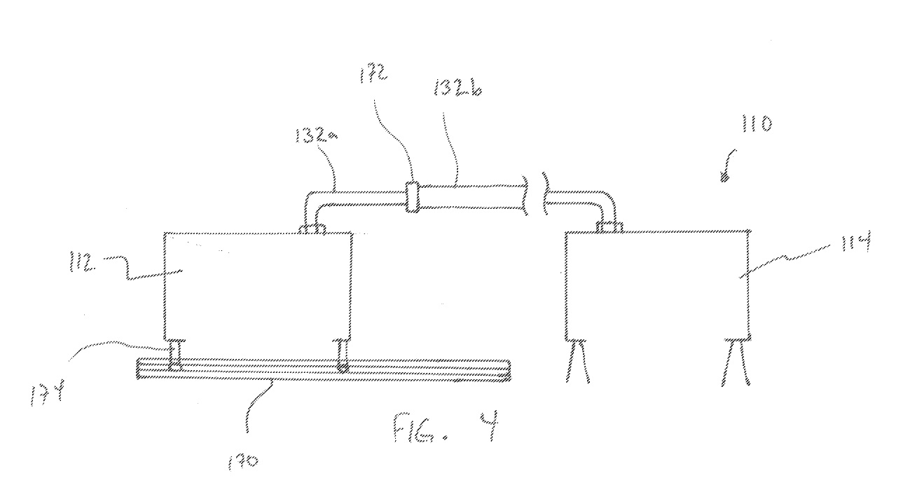

As noted above, the inventors have found that the tanks should generally be spaced one half of the period of one wave propagating across the body of water. The period of waves may vary depending on tidal changes or other influencing factors. Accordingly, FIG. 4 shows an alternative embodiment of an apparatus 110 similar to the apparatus 10 of FIG. 1 but in which first and second tanks 112, 114 are moveable relative to each other. More specifically, the first tank 112 is mounted on a rail 170 and is moveable along the rail to selectively increase or decrease the distance between the first and second tanks 112, 114. To accommodate this change, the conduit 132 leading from the first tank 112 to the valve (not shown) contains two sections 132a, 132b that are telescopic. The first section that is, 132a is slideable into segment 132b to selectively increase or decrease the overall length of the conduit. FIG. 4 also shows schematically a sliding seal 172 that maintains a seal between segments 132a and 132b of the conduit as those sections slide relative to each other. In this manner, water is not allowed to enter at the joint between 132a and 132b and air will not escape the conduit there through.

The first tank 112 is illustrated as being mounted on rollers that roll along the track 170, although the invention is not limited to this embodiment. Any known actuating means that will selectively change the distance between the two tanks 112, 114 could be employed. Moreover, the second tank 114 is shown as being stationary and the first tank 112 is moved along the rail 170, but this is not necessary. In an alternative embodiment, the first tank 112 is stationary and the second tank 114 moves relative thereto. In still an other embodiment, both tanks 112, 114 could be disposed for relative movement.

Although the system will generally be sized to the body of water to be used and the desired output of energy, one example the apparatus utilizes tanks 12, 14 that are forty feet square by twenty feet high and the conduit is a steel pipe of six to ten feet in diameter. As will be appreciated by those of ordinary skill in the art upon reading this disclosure, the pressure at which air enters the motor 50 can be altered, and theoretically optimized, by selecting appropriate sizes of passageways, including the conduit diameter and valve sizing.

Although the apparatus 10, 110 could be submerged anywhere in a body of water, it is preferable that they be disposed such that every portion of the apparatus is submerged a minimum of fifty feet, so as not to effect seagoing vessels. Moreover, the further the tanks are submerged, the higher the pressure of the air in the tanks, which will lead to greater energy extraction. In one embodiment, the apparatus are fixed to the bottom of the body of water, using known anchoring techniques. In other embodiments, the apparatus may be entirely formed on a plate or a base, which is then submerged in the body of water.

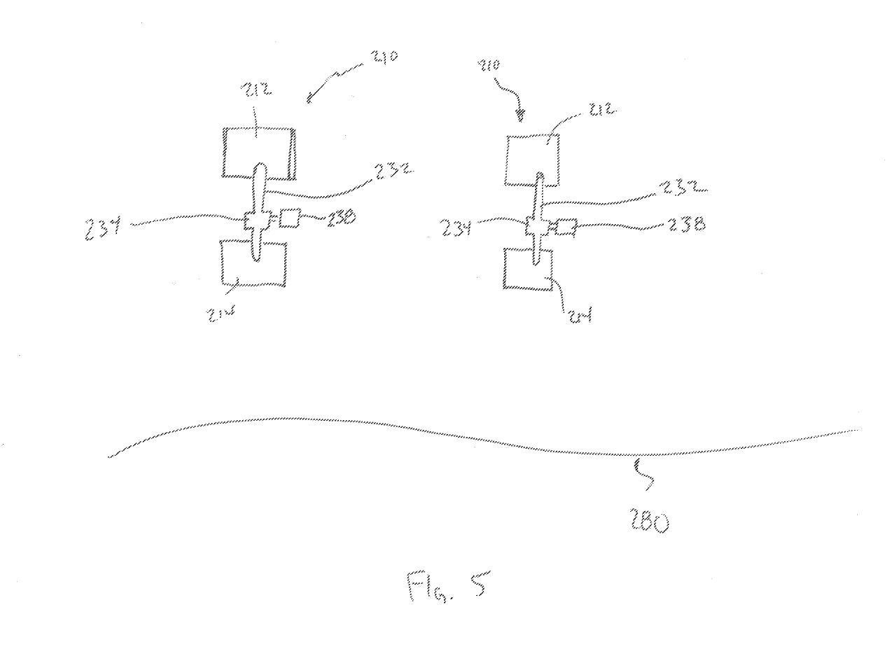

FIG. 5 is an illustration of a plan view showing an arrangement of two apparatus 210, such as those described above, relative to the shoreline 280. Each of the apparatus 210 includes first and second tanks 212, 214, a conduit 232, a valve 234, and a housing 238 containing the motor and generator. As illustrated, each of the apparatus 210 is disposed substantially equidistantly from the shore 280.

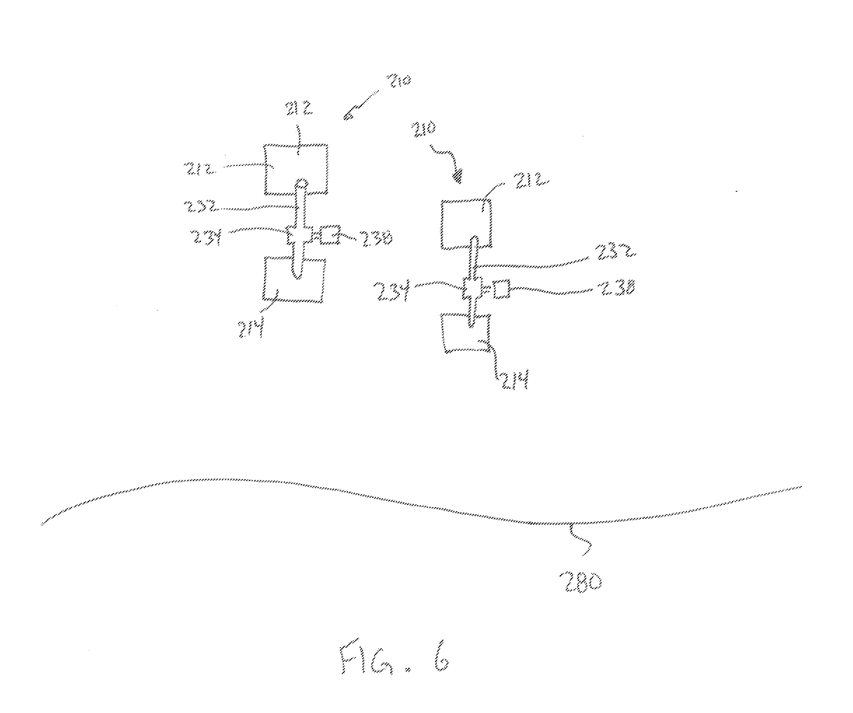

FIG. 6 is an alternative to the arrangement of FIG. 5, in which the apparatus 210 are staggered relative to each other. In this manner a wave propagating perpendicularly to the shore will first pass over the apparatus 210 disposed further away from the shore 280 and then over the apparatus disposed more closely to the shore. In this manner, when the energy output from the generator from each of the apparatuses is put together, a more continuous output of energy is achieved by adding all of the energy outputs from each of the generators in each apparatus 210. Put another way, in the embodiment of FIG. 5, as the wave passes over each of the first tanks 212, a pulse of energy will be obtained in each generator associated with each of the apparatus 210. As the wave further propagates and crests over the second tank 214, another pulse of energy will be achieved. When the crest of the wave is not directly over either of the tanks, the energy output will be much lower, and may fall to zero. Thus, adding all of the pulses from all of the generators will result in a substantially uniform pulse structure, assuming the waves are propagating perpendicular to the coast 280, with potentially large fluctuation between peak and trough. In the embodiment of FIG. 6, though, a pulse is still achieved each instance of a crest passing over a tank, but by staggering the tanks along a direction perpendicular to the shoreline 280, adding the energy output of each of the generators for each apparatus 210 will provide a lower amplitude of energy, but at a more frequent time frame, which may be more desirable in certain applications.

Although not shown, energy output from the generators of the respective apparatus according to the invention may be transmitted via cable to a location on shore or above the water for consumption in any given manner. To the extent energy is required to drive any of the components of the apparatus of the invention, the energy extracted may be put back into the system to so drive those components. For example, when the valve 234 includes an actuator, that actuator may be driven by energy withdrawn from the system.

As will be appreciated from FIGS. 5 and 6, the inventors contemplate a system including a plurality of apparatus. Each apparatus may have its own air motor and generator, as illustrated, or in an alternative embodiment, only a single generator may be provided, i.e., receiving inputs from more than one air motor. In yet another embodiment, a single air motor or turbine could be provided, with appropriate air plumbing between the different apparatus to receive the compressed air therefrom. Other modifications also will be appreciated by those of skill in the art upon studying this disclosure.

In theory, the compressed air within the system that circulates between the spaced tanks to drive the motor is maintained at a substantially constant volume. However, it may be possible, due to inefficiencies in the system, such as leaks at joints or the like, or air dissolving into the water that air is lost from the system. Accordingly, the apparatus may further be provided an air supply to replenish any air lost from the system as a result of these inefficiencies.

While the invention has been described in connection with severally presently preferred embodiments thereof, those skilled in the art will appreciate that may modifications and changes may be made without departing from the spirit and scope of the invention, which accordingly is intended to be defined solely by the appended claims.

1. An apparatus for extracting energy from waves traversing a body of water comprising:
first and second tanks submerged in the body of water and spaced apart in the direction of movement of a wave, each having an opening close to the bottom for allowing water to enter, an air outlet above the opening outlet, and containing a volume of air;
first and second floating flap valves, one arranged in each of the tanks to selectively allow air to flow between the respective tank and the associated tank outlet but prevent the flow of water our the tank outlet;
a conduit connecting the tank outlets of the first and second tanks;
an air propelled motor;
a valve disposed in the conduit and having first and second valve outlets directing air through the motor from the tank outlet associated with the one of the first and second tanks having a higher pressure to the tank outlet associated with the other of the first and second tanks having a lower pressure; and
a generator connected to the motor for converting rotation of the motor into electricity.

2. The apparatus of claim 1, wherein the first and second tanks are spaced a distance of approximately one-half a period of a water wave in the body of water.

3. The apparatus of claim 1, wherein the first and second tanks are movable horizontally relative to each other to change the distance therebetween.

4. The apparatus of claim 3, wherein the first and second tanks are movable horizontally relative to each other to maintain a distance of approximately one-half a period of a wave in the body of water.

5. The apparatus of claim 4, wherein the conduit includes a sliding joint allowing an overall length of the conduit to change to accommodate the change in distance between the first and second tanks.

6. The apparatus of claim 1, further comprising a flywheel connected to the air motor.

7. The apparatus of claim 1, wherein the first outlet of the valve is in fluid communication with one of an inlet port and an outlet port of the air motor and the second outlet of the valve is in fluid communication with the other of the inlet port and the outlet port of the air motor.

8. The apparatus of claim 7, wherein a pressure differential between the first and second tanks causes air to flow into the air motor through the inlet port, actuating the air motor.

9. The apparatus of claim 7, further comprising an actuator to selectively actuate the valve to allow passage of higher-pressure air from either of the first and second tanks through the outlet of the valve in fluid communication with the inlet port of the air motor.

10. The apparatus of claim 9, wherein the actuator is an air cylinder.

11. The apparatus of claim 10, wherein exhaust air from the cylinder is exhausted into the four-way valve via the outlet of the valve in fluid communication with the outlet port of the air motor.

12. The apparatus of claim 1, further comprising an air supply introducing air into at least one of the conduit, the four-way valve, and the first and second spaced tanks to maintain a minimum amount of air in the apparatus.

13. The apparatus of claim 1, wherein the floating flap valves selectively allow and impede flow based on the water level of the volume of air in the respective first and second tanks.

14. An apparatus for extracting energy from waves traversing a body of water comprising:
first and second tanks submerged in the body of water and spaced apart in the direction of movement of a wave, each having an opening close to the bottom for allowing water to enter, an air outlet above the opening outlet, and containing a volume of air;
a conduit connecting the air outlets of the first and second tanks;
an impeller disposed to be turned by compressed air passing through the conduit; and
a generator connected to the impeller for converting rotation of the motor into electricity.

15. The apparatus of claim 14, wherein the impeller is disposed in the conduit.

16. The apparatus of claim 14, wherein the impeller is disposed in a housing spaced from the conduit.

17. The apparatus of claim 16 further comprising a valve disposed in the conduit, and selectively directing compressed air from the conduit to the housing to turn the impeller.

18. The apparatus of claim 14, further comprising a floating flap valve arranged in at least one of the first and second tanks.

19. A system for extracting energy from waves traversing a body of water comprising a plurality of connected apparatus according to claim 1.

20. A system for extracting energy from waves traversing a body of water comprising a plurality of connected apparatus according to claim 14.
